(19) United States
(12) Patent Application Publication
(10) Pub. No.: US 2021/0339550 A1
(43) Pub. Date: Nov. 4, 2021

(54) Adjustable decorative book cover

(71) Applicants: Robert Melbourne Forrest, San Antonio, TX (US); Sarah Katherine Forrest, San Antonio, TX (US)

(72) Inventors: Robert Melbourne Forrest, San Antonio, TX (US); Sarah Katherine Forrest, San Antonio, TX (US)

(21) Appl. No.: 17/120,108

(22) Filed: Dec. 12, 2020

Related U.S. Application Data
(60) Provisional application No. 62/947,229, filed on Dec. 12, 2019.

(51) Int. Cl. B42D 3/02; B42D 3/08

(52) U.S. Cl. CPC B42D 3/02; B42D 3/08

(57) ABSTRACT

A decorative book cover with only one folded front flap and an evenly spaced grid printed on the inside surface that can be used to cover books of all sizes and binding types and give them a uniform, color-coordinated, decorative effect for styled shelves and displays. The front panel of a books cover can be inserted in the front flap of the cover so that the cover can be pulled tight around the book and wrapped just like a normal cover and the back flap then folded like a classic paper dust jacket and then easily removed and fitted to another book of a different size; the printed grid allows for easily trimming the cover down for odd sized books.

### CROSS-REFERENCE TO RELATED APPLICATIONS

This patent application claims the benefit of U.S. Prov. Ser. No. 62/947,229 filed Dec. 12, 2019.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates to paper book covers (dust jackets) and how they are used in the field of home décor and interior design. One characteristic feature of a book's dust jacket is that its decoration and material are intended to delight the eye. Previously, many books have been chosen to be displayed on coffee tables, book shelves, etc. in color coordinated displays for decorative purposes because of their aesthetically pleasing look.

However, decorative displays using books have previously required finding particular books with specific and matching (or coordinated) covers one at time with all the time and expense this entails. Or such decorative displays have required using materials such as fabric (e.g. U.S. Pat. No. 5,219,437A), wood, plastic, leather, stretchable material (e.g. U.S. Pat. No. 6,257,622B1), etc. to cover non-specific or random books with decoration in such a way as to produce the intended stylized result (e.g. CN201659760U). While usable with random books, these other coverings substantially change the look and feel of books in many undesirable ways such as making the books feel and look bulky, fake, childish, or inappropriately school-like, as in the case of textbook covers. Moreover, these alternative book coverings require time-consuming, costly, or complicated fitting to a book's specific size and thickness, or if they do include some mechanism for fitting multiple sizes of books (e.g. U.S. Pat. Nos. 5,029,900A, 2,145,099A, 4,341,401A, 4,715,619A, 4,274,659A, 3,891,240A, 4,527,814A, 3,972,632A), these alternative book covers are primarily protective in nature and intention, oftentimes adhered to the book itself, and not suitable for beautiful décor.

There is a need for classic paper dust jackets that maintain the look and feel like traditional books and are decorative, reusable, interchangeable, easily obtainable, cost effective, quick to install on any common book, and attractive in appearance so that the covered books can be utilized in styled shelves, displays, and décor.

### BRIEF SUMMARY OF THE INVENTION

The disadvantages and limitations of the prior art discussed above are overcome by the present invention. The invention provides a traditional paper book cover which maintains the look and feel of books and which is easily fitted to any common book by the improvement of keeping the classic front fold of a dust jack to hold the book in place for fitting while removing the traditional back folded flap and keeping the book jacket unfolded in order to use a wrap-around method on the back of the book to accommodate different sized books and by the improvement of a grid that is printed on the inside of the cover to facilitate precise and easy cutting for odd sizes in order to provide unique, color-coordinated decorative effects from the images, texts, patterns, and colors printed on the outside surface of the book cover. These covers can eliminate the need for costly procurement of specific books of specific colors and design, because a set of these invented covers can quickly be placed on any random books readily available to the user, both hard cover and softcover, transforming any and all books into color coordinated, uniform décor elements. Because they are sized for a range of thicknesses, these invented covers can be reused on different books in different combinations for different seasons and occasions depending on the colors, patterns, or designs printed on the outside surface all while maintaining the look and feel of classic books that are aesthetically pleasing and not at all child-like, school-like, office-like or negatively industrial in appearance. This invention improves on the prior art by making the previously classic book jacket that was specific to a specific book into a versatile tool for home décor and decoration without sacrificing form for function.

### BRIEF DESCRIPTION OF THE SEVERAL VIEWS OF THE DRAWING

These and other objects and advantages of the present invention will become apparent from the following detailed description, with reference to the accompanying drawings wherein:

FIG. 1 is a top down view of the invention lying flat with the front flap on the left and the inside surface facing up with the evenly spaced grid.

FIG. 2 is similar to FIG. 1 with the addition of an open book lying on top of the invention with its front panel cover inserted into the front flap.

FIG. 3 is similar to FIG. 2 but from the bottom side perspective instead of from above.

FIG. 4 is similar to FIG. 3. but with the book pages flipped to the left and showing the back flap of the cover being folded over the back panel cover of the book.

FIG. 5 shows the book covered with the invention and closed from the perspective of the pages side of the book and with the spine not in view.

FIG. 6 shows three books covered with the invention and standing up with uniform heights because of the invention making the actual height of the book immaterial.

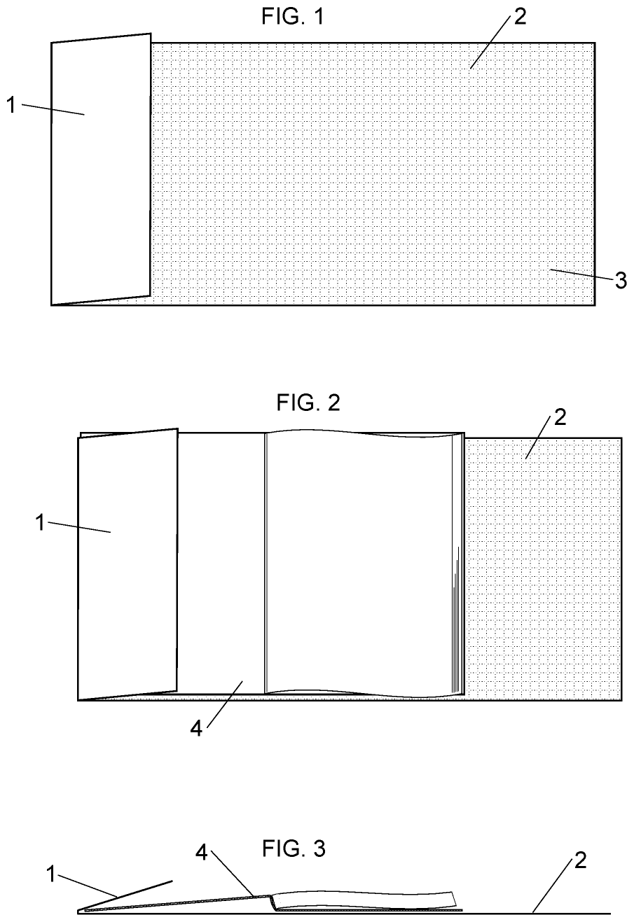

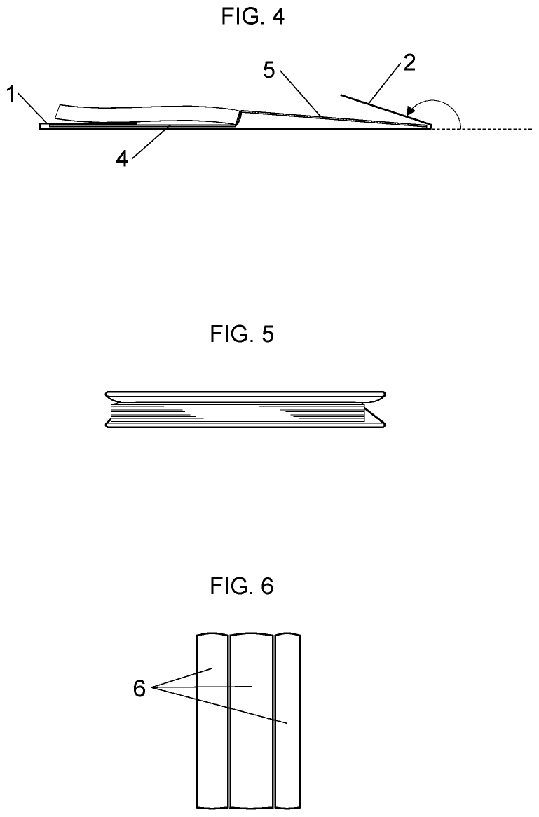

### DETAILED DESCRIPTION OF THE INVENTION

Although the invention can be made from any sort of paper and printed with any desired design, the book cover is ideally printed on 80 mil paper to conform to common standards for dust jacket printing and coated with a standard laminate coating on the outside surface during printing. The inside surface of the cover is printed with a grid of lines that is comprised of 1 cm squares. It is printed as a rectangular sheet in a range of sizes corresponding to the standard heights and widths of paper dust jackets. For example, a book jacket intended for standard 9″ by 6″ books should be 9.25″ tall by 21.5″ as explained and detailed below. Book jackets for other common book sizes can similarly be produced.

Instead of needing to be sized to a particular book, the book jacket can be snugly wrapped around books of varying thicknesses within a range of thicknesses. The book cover can ideally be precut by the printer to fit the ideal height of a common book height and size, e.g. one standard hardcover size sold widely is 9″ tall by 6″ wide. Professionally fitted dust jackets are cut to be ¼″ taller so as to slightly stick out beyond the top and bottom of the book and therefore fully cover the book; a book cover intended for this common hardcover size should therefore have a height of 9.25″. Covers of a particular standard height can then be used to cover all books of varying thicknesses within the particular height of book, both hardcover and softcover.

Additionally, the inside surface of the dust jacket has a preprinted grid of 1 cm squares so as to facilitate easy cutting down of cover to more perfectly fit books of odd sizes by trimming the top and/or bottom edges of the book cover down along the grid lines to the desired height. Or the cover can be used on smaller sized books uncut and stick up above the height of the actual book in order to create a uniform look and size to improve the coordination possible in the décor design so that the user can utilize books of different heights already available to him or her to create a uniform decoration.

Ideally, the book cover comes with the front flap pre-folded so as to be ideally ⅓ to ⅔ the width of the cover width of the standard sized book the cover is ideally intended for (e.g. for a standard 9″ by 6″ book the front flat can be pre-folded by a printer to be 4″ wide). The rest of the cover is flat and unfolded until first wrapped around a book. The length of the cover is sized to be sufficiently long to wrap books of varying thicknesses within the standard height and width the cover is ideally intended for. The method of determining length of the cover is to calculate the length of a cover intended for a 1″ thick book of a particular size, and this is sufficient to cover most books in that size. 0.5″ is also added to the length to account for length of the cover that is lost in wrapping the cover around the edges of the books front and back boards. For example, a 9″ by 6″ standard hard cover has a 6″ front panel, a 6″ back panel, and a 1″ spine. Ideal front and back book cover flaps that provide a snug fit and appealing look are 4″ wide (⅔ the width of the book/front and back panels). Adding this together (6+6+4+4+1+0.5) yields a length of 21.5″. A finished cover for a 9″ by 6″ book should therefore be 21.5″ long to accommodate very thin books up to very thick books of 4″ thick (assuming maintaining at least a 1″ back flap).

Combining the above, a book cover ideally intended for a standard 9″ by 6″ book would be 9.25″ by 21.5″. Following the method above can easily yield the book cover size for any standard sized books, e.g. for 8″ by 5″ books. Most books in the US and in the world are sold in a limited number of different dimensions, and a set of book covers according to this invention in the most popular three sizes would easily cover almost all books found in the US, both hardcover and softcover, thereby improving on prior art, although more specific sized book covers could easily be printed according to this invention, as well. The invention further provides the easy ability to cut the cover cleanly using the 1 cm grid that is printed on the inside of the cover by centering the book on the cover and trimming the excess of the cover ideally 0.25″ beyond the edge of the book.

The method for wrapping the book is to snugly place the front cover of the book in the front flap and to wrap the cover around the book, pulling it tight as the book lies open. The cover is then wrapped and folded around the back flap of the book itself while simultaneously closing the book so as to pull cover tight and create a snug fit. The back flap of the book cover is folded at different locations depending on the thickness of the book thereby creating back flaps of different widths depending on the book. The grid on the inside surface of the cover can be used to trim the back flap of the cover to match the front flap width if the back cover flap is wider than the front (if so desired).

This method of using standard book sizes and standard paper dust jacket construction when combined with the improvement of leaving the back flap unfolded until wrapping and using the above method for wrapping the book produces a book cover that can be used on almost any book while maintaining the look and feel of a real book that actually had a matching cover printed for it. Softcover books can now look like hard cover books and uniformity can be created among differently sized books.

This method of folding paper by hand upon application also allows for better reuse. A book with a spine of 3″ thick can be easily covered then uncovered, and the cover can then be reused on a 2″ thick book by simply refolding the back cover to accommodate size differences. Utilizing different thicknesses of paper and paper coatings can even further make the invention reusable as some semi-gloss coatings hide folds more easily and folds created using the above method stand out significantly less than folds created using machines, therefore improving the invention's versatility and utility.

The ideal method for designing color coordinated shelves and displays using books is to create the invention above with solid color printing on the outside surface of the cover. Print covers in various shades and colors, and these covers can be flexibly and cost effectively combined to create innumerable aesthetically pleasing displays of books without the great cost and time of sourcing specific books one by one. This method also avoids the failings of protective book covers that are not suitable in appearance for décor and that change the look and feel of a book to be non-book-like. The book covers can even be moved to different books to create seasonal décor depending on the colors printed.

1. A decorative book cover comprising:
a rectangular sheet having an outside surface and an inside surface, said rectangular sheet having a left end and a right end when viewed lengthwise, said outside surface being covered with a decorative design; and
a front flap, which is formed by said left end being folded away from said front surface back onto said inside surface;
whereby to fit said decorative book cover to a book, a front panel cover of said book is inserted into said front flap while said book is open, said right end wrapping around a back panel cover of said book to form a back flap as said book is closed, fitting said decorative book cover tightly and snugly to said book, said decorative book cover easily removable for placement on another book, said back flap being refolded around a new back panel cover at a new fold point.

2) A decorative book cover as defined in claim 1, wherein said rectangular sheet is made from paper or a paper-like substance.

3) A decorative book cover as defined in claim 1, wherein said inside surface is printed with an evenly spaced grid;
Whereby to fit said book inside said decorative book cover said decorative book cover is trimmed of excess material using a straight line of said evenly spaced grid.

4) A decorative book cover as defined in claim 1, wherein said decorative book cover extends beyond a small book's height creating a new uniform height for multiple books.
